(19) United States
(12) Patent Application Publication
(10) Pub. No.: US 2012/0303754 A1
(43) Pub. Date: Nov. 29, 2012

(54) METHOD OF BROKERING DIGITAL DATA

(75) Inventor: Isao TAKAHASHI, Kosigaya-shi (JP)

(73) Assignee: NIKON CORPORATION, Tokyo (JP)

(21) Appl. No.: 13/565,407

(22) Filed: Aug. 2, 2012

Related U.S. Application Data
(63) Continuation of application No. 13/067,676, filed on Jun. 20, 2011, now abandoned.
Application No. 13/067,676 is a continuation of application No. 10/473,061, filed on Sep. 26, 2003, now abandoned.

(30) Foreign Application Priority Data
Mar. 27, 2001 (JP) 2001-089736
Mar. 27, 2001 (JP) 2001-089737

(51) Int. Cl. G06F 15/16

(52) U.S. Cl. 709/217

(57) ABSTRACT

A photographer 2 registers photographing availability information by accessing a server at a service provider 3 from his terminal (S 1). A photograph client 1 registers photographing request information by accessing the server at the service provider 3 from a home terminal (S 2). The photograph client 1 selects a photographer 2 to be assigned to photograph a subject desired by the client based upon registered photographing availability information provided by photographers 2 (S 3). The selected photographer 2 performs a photographing operation (S 4). The photographer 2 registers a photographed image at the server of the service provider 3 (S 5). The photograph client 1 receives the image from the server of the service provider 3 (S 6).

This is a Continuation of U.S. patent application Ser. No. 13/067,676, filed Jun. 20, 2011, which is a Continuation of U.S. patent application Ser. No. 10/473,061 filed Sep. 26, 2003, which in turn is a National Phase Application No. PCT/JP02/02981 filed Mar. 27, 2002. The disclosure of each of these prior applications is incorporated herein by reference in its entirety.

### INCORPORATION BY REFERENCE

The disclosures of the following priority applications are herein incorporated by reference:

Japanese Patent Application No. 2001-89736 filed Mar. 27, 2001
Japanese Patent Application No. 2001-89737 filed Mar. 27, 2001

### TECHNICAL FIELD

The present invention relates to a method of brokering digital data, a method of providing digital data, a digital data brokering system, a program for digital data brokering services, a method of brokering image data and an image data brokering system.

### BACKGROUND ART

(1) A person obtains an image photographed at a desired location by hiring a photographer on a photographing assignment or by traveling to the location to photograph the image himself. When an image of a distant location is desired, the photographer must spend a considerable length of time traveling to the location. For this reason, a current image of the location cannot be obtained easily. In addition, even though a photographer currently present in the vicinity of the desired photographing location may be hired on assignment, it takes time to find out the photographer's schedule and contact number. As a solution to the problems discussed above, the inventor of the present invention conceived a system through which a service that accepts a photographing request placed by a third party who is not an acquaintance or a friend and contracts a third party on a photographing assignment is provided.
(2) A person visiting a given location may decide that he would like to obtain an image photographed at the same location but on a different day or in a different season. In such a case, he needs to hire a photographer on a photographing assignment at a later date or to go back to the location himself to photograph the image. As a solution to this problem, the inventor of the present invention has conceived a system through which a brokering service that brokers images having been photographed in the past by third parties who are not friends or acquaintances is provided.

### DISCLOSURE OF THE INVENTION

An object of the present invention is to provide a method of brokering digital data, a method of providing digital data, a digital data brokering system, a program for digital data brokering services, a method of brokering image data and an image data brokering system.

In a digital data brokering method according to the present invention, current positional information originating from digital data creators is obtained, the current positions are posted to the public, a creation request sent in by a digital data creation client based upon the posted current positions is obtained, a creation instruction is transmitted to a digital data creator corresponding to the creation request thus obtained and digital data created by the creator after receiving the creation instruction are delivered to the client.

In another aspect of the digital data brokering method according to the present invention, availability information originating from a digital data creator is obtained, request inf ormation originating from a digital data client is obtained, a digital data creation instruction is transmitted to a creator determined based upon the availability information and the request information and digital data created by the creator after receiving the creation instruction are delivered to the client.

The digital data brokering method may have a plurality steps in which a decision is made that a request condition and an availability condition respectively originating from a digital data creation client and a digital data creator match each other, a digital data creation instruction is transmitted to the creator with the availability condition achieving a match and digital data created by the creator after receiving the creation instruction is delivered to the client.

In a digital data providing method according to the present invention, current positions of digital data creators are obtained, a requested position indicated by a digital data creation client is obtained, the current positions and the requested position thus obtained are compared, an instruction to permit a digital data creator currently located at a position matching the requested position to create digital data is issued and digital data created by the digital data creator having received the instruction are delivered to the client.

A digital data brokering system according to the present invention comprises a first recording device that records availability information that includes positional information indicating positions of digital data creators and originates from the creators, a second recording device that records request information that includes a desired digital data creation condition indicated by a client and originates from the client, a comparison device that compares the availability information and the request information, a transmission device that transmits a digital data creation instruction to a creator having originated availability information with at least positional information thereof judged to satisfy the creation condition as a result of the comparison executed by the comparison device and a monitor device that monitors the delivery of digital data created by the creator after receiving the creation instruction to the client.

An image data brokering system according to the present invention comprises an accepting terminal having a positional information generating device for generating positional information, from which availability information provided by an image data creator originates, a requesting terminal from which request information provided by a client originates and a server that receives the availability information and the request information. The server includes a comparison device that compares the availability information and the request information, a transmission device that transmits results of the comparison to the requesting terminal and a transfer device that transfers a request instruction originating from the requesting terminal to the accepting terminal. The accepting terminal includes a transmission device that transmits image data created in conformance to the request instruction to the server or the requesting terminal.

A digital data brokering services program according to the present invention enables execution of first receiving/transmitting processing through which the availability information that includes positional information indicating a position of a digital data creator and originates from the creator is received/transmitted, second receiving/transmitting processing through which request information that includes a desired digital data creation condition indicated by a client and originates from the client is received/transmitted, comparison processing through which availability information and the request information are compared, third receiving/transmitting processing through which a digital data creation instruction is transmitted to/received by the creator if at least the positional information is judged to satisfy the creation condition as a result of the comparison processing and fourth receiving/transmitting processing through which information required to deliver digital data created by the creator after receiving the creation instruction to the client is received/transmitted.

In a digital data brokering method according to the present invention, desired digital data creation location information originating from digital data creation clients is obtained, the desired creation locations are posted to the public, creation acceptance sent in by a digital data creator based upon the posted desired creation location is obtained, the creation acceptance is transmitted to a digital data creation client determined in correspondence to the creation acceptance thus obtained and digital data created by the creator after transmitting the creation acceptance are delivered to the client.

In another aspect of the digital data brokering method according to the present invention, request information that includes information indicating a desired digital data creation location and originates from a client is obtained, availability information that includes information indicating possible digital data creation locations and originates from digital data creators is obtained, the request information and the availability information are compared, a digital data creation instruction is transmitted to a creator having originated availability information indicating a possible digital data creation location matching the desired digital data creation location and digital data created by the creator after receiving the creation instruction are delivered to the client.

In an image data brokering method according to the present invention, request information that includes information indicating desired photographing locations and originates from clients is obtained, availability information that includes information indicating a possible photographing location and originates from a photographer is obtained, a search is conducted for request information meeting a requirement placed by the photographer based upon the desired photographing locations indicated in the request information and the possible photographing location indicated in the availability information, an assignment acceptance instruction issued by the photographer in response to results of the search is received, a request instruction issued by a client selected through the assignment acceptance instruction is received, a photographing instruction is transmitted to the photographer having transmitted the assignment acceptance instruction after receiving the request instruction and image data created after the photographer receives the photographing instruction are delivered to the selected client.

In a digital data providing method according to the present invention, at least one requested position is selected from positions requested by a plurality of digital data creation clients and information that is needed by a client to obtain digital data created at the selected requested position is transmitted to the client.

A digital data brokering system according to the present invention comprises a first recording device that records request information that includes a creation condition under which desired digital data are to be created and originates from a client, a second recording device that records availability information transmitted by a creator, a comparison device that compares the request information and the availability information, a transmission device that transmits a digital data creation instruction to the creator if results of the comparison executed by the comparison device indicate that the creation condition matches the availability information and a monitor device that monitors the delivery of digital data created by the creator after receiving the creation instruction to the client.

An image data brokering system according to the present invention comprises a requesting terminal from which request information provided by a client originates, an accepting terminal from which availability information provided by an image data creator originates and a server that receives the availability information and the request information. The server includes a comparison device that compares the availability information and the request information, a transmission device that transmits results of the comparison to the accepting terminal and a transfer device that transfers an assignment acceptance instruction originating from the accepting terminal to the requesting terminal and also transfers a request instruction originating from the requesting terminal to the accepting terminal. The accepting terminal includes a transmission device that transmits image data created in conformance to the request instruction to the server or the requesting terminal.

A digital data brokering services program according to the present invention enables execution of first receiving/transmitting processing in which request information that includes a creation condition under which desired digital data are to be created and originates from a client is received/transmitted, second receiving/transmitting processing in which availability information originating from a creator is received/transmitted, comparison processing in which the request information and the availability information are compared, third receiving/transmitting processing in which a digital data creation instruction is transmitted to/received by the creator if results of the comparison processing indicate that the creation condition matches the availability information and fourth receiving/transmitting processing in which information needed to deliver digital data created by the creator after receiving the creation instruction to the client is received/transmitted.

According to the present invention described above, the availability information that includes positional information indicating the position of a digital data creator and request information that includes a creation condition under which digital data are to be created and originates from a client are compared, a digital data creation instruction is issued to the creator if at least the positional information satisfies the creation condition and digital data created after the creation instruction is issued are delivered to the client. As a result, a system through which a service that entrusts a third party who is not a friend or acquaintance with a digital data creation assignment and accepts a creation request placed by a third party is provided is achieved.

In addition, since the positional information indicating the current position of the creator included in the availability information is updated, a data creation request can be placed in correspondence to the latest positional information even while the creator is on the move.

In a digital data brokering method according to the present invention, digital data originating from digital data creators and information indicating locations at which the digital data have been created are obtained and registered, the digital data are posted to the public together with the creation locations, a digital data acquisition request issued by a digital data acquisition client based upon the posted creation locations is obtained and digital data determined in correspondence to the acquisition request thus obtained are delivered to the client.

In another aspect of the digital data brokering method according to the present invention, creation location information indicating creation locations at which the digital data have been created and originating from digital data creators is obtained, digital data acquisition request information that includes current location information indicating a current position of an acquisition client and originates from the client is obtained, the creation location information and the current location information are compared and digital data corresponding to creation location information matching the current location information are delivered to the client based upon results of the comparison.

In an image data brokering method according to the present invention, photographing location information indicating photographing locations at which image data have been photographed is obtained, current location information indicating a current location of an acquisition client is obtained, a search is conducted for photographing location information satisfying a requirement of the client based upon at least the current location information and the photographing location information, a request instruction issued by the client in response to results of the search is received and image data corresponding to the selected photographing location information are delivered to the client after receiving the request instruction.

A digital data brokering system according to the present invention comprises a first recording device that records creation location information indicating creation locations at which digital data have been created and originating from digital data creators, a second recording device that records request information that includes current location information indicating a current location of a client and originates from the client, a comparison device that compares the creation location information and the current location information and a monitor device that monitors the delivery of digital data corresponding to creation location information matching at least the current location information to the client based upon results of the comparison executed by the comparison device.

An image data brokering system according to the present invention comprises a requesting terminal having a positional information generating device for generating information indicating a current position of an image data purchase client, from which request information provided by the client originates and a server that records image data photographing locations and also receives the request information. The server includes a comparison device the compares the photographing locations and the current position, a first transmission device that transmits results of the comparison to the requesting terminal and a second transmission device that transmits image data corresponding to a request instruction originating from the requesting terminal to the requesting terminal.

A digital data brokering services program according to the present invention enables execution of first receiving/transmitting processing through which digital data creation location information originating from digital data creators is received/transmitted, second receiving/transmitting processing through which request information that includes current location information indicating a current location of a client and originates from the client is received/transmitted, comparison processing through which the creation location information and the current location information are compared and third receiving/transmitting processing through which information needed to deliver digital data with at least the creation location information thereof judged to match the current location based upon results of the comparison processing to the client is received/transmitted.

In addition, according to the present invention, the digital data creation location information and the current location information indicating the current location of a digital data creation client are compared, and if a common position is indicated by at least creation location information and the current location information, digital data corresponding to the creation location information are delivered to the client. As a result, a system through which a service that brokers data created in the past by a third party who is not a friend or acquaintance is provided can be achieved.

### BRIEF DESCRIPTION OF THE DRAWINGS

FIG. 1 shows an overview of a flash report-type image brokering services;

FIG. 2 shows an overall configuration of a system through which the service shown in FIG. 1 is offered;

FIG. 3 shows the structure adopted at the server of the service provider;

FIG. 4 shows the structure of the photographer's terminal;

FIG. 5 presents examples of search screens brought up on display at the display at the home terminal;

FIG. 6 shows an overview of an advance booking-type image brokering services;

FIG. 7 shows an overview of an archive-type image brokering services;

FIG. 8 shows an overall configuration of a system through which the service shown in FIG. 7 is offered; and

FIG. 9 presents an example of the at-a-glance image display brought up on display at the terminal screen.

### BEST MODE FOR CARRYING OUT OF THE INVENTION

The following is an explanation of embodiments of the present invention, given in reference to the drawings.

### First Embodiment

The image brokering services achieved in the first embodiment is a flash report-type image brokering services through which an image photographed in real time by a photographer in response to a photographing request placed by a photograph client is promptly provided to the client. The term “image” as used in this context refers to image material information and information appended to image (referred to as image appended information). The image material information contains at least either at still image or a dynamic image. The image may include audio information. The still image may be a 3-D image or a 360° panorama image.

The image appended information includes photographing positional information, photographer information, photographing information, terminal inherent information, explanatory information, disclosure information and remuneration information. The photographing positional information includes the photographing longitude and latitude, the photographing altitude, the photographing azimuth (direction) and a map (indicating the photographing position) or a typical image photographed at the photographing position. The photographer information includes personal information to be detailed later. The photographing information includes the date and time at which the image was photographed, the exposure time set for the photographing operation, the shutter speed and the aperture value set for the photographing operation. In addition, if a dynamic image or audio information is included in the image material information, the photographing information also contains information indicating the recording time point at which the image material information was recorded. The terminal inherent information includes the terminal name of the photographing apparatus and the terminal identifier assigned to the photographing apparatus. The explanatory information includes a title, a caption, a key word and a photographing location (name of the country, prefecture, town, etc.). The disclosure information includes the range over which the image may be posted (e.g., only to a specific individual, a specific group of individuals or unrestricted) and the duration over which the image may be posted (e.g., a specific date/time, a specific period of time, unrestricted). The remuneration information includes information indicating a specific amount of monetary payment (including information that indicates the image is offered free of charge) and information indicating the method of payment (a means for settlement).

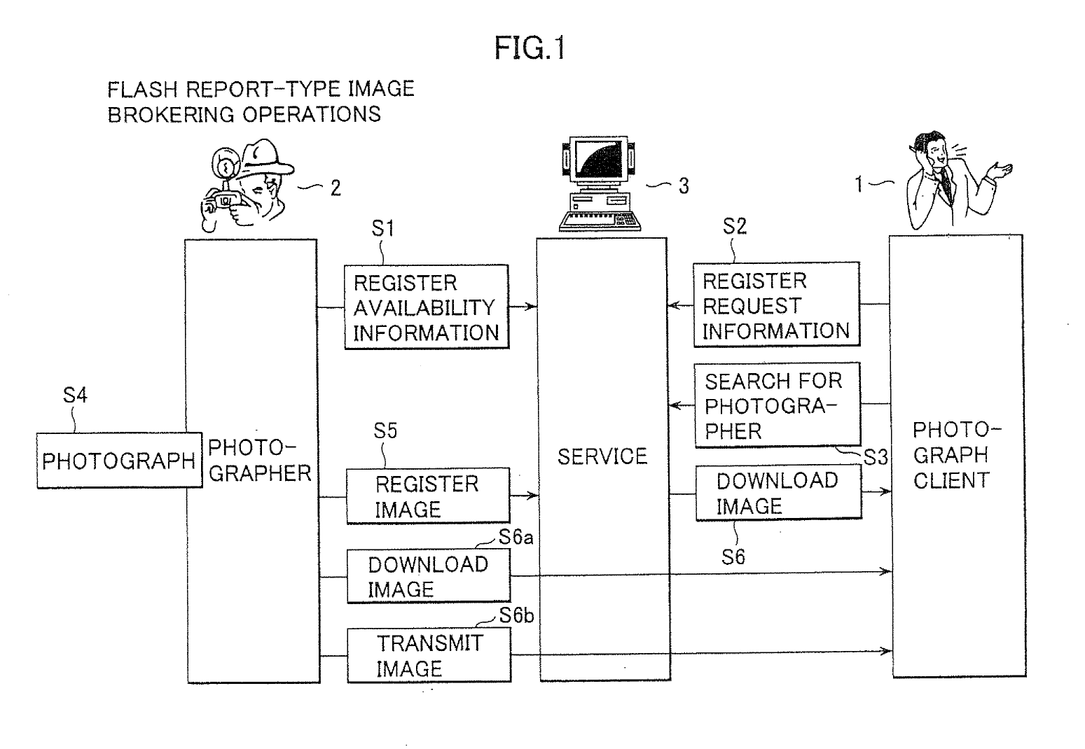

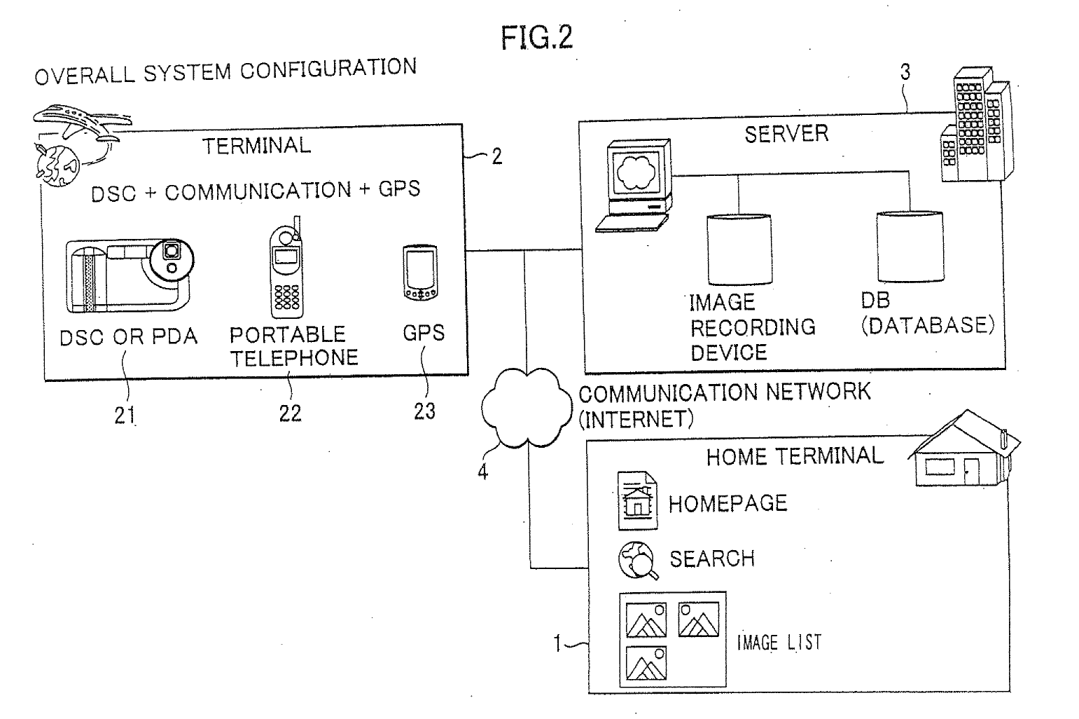

FIG. 1 is provided to facilitate an explanation of the overview of the flash report-type image brokering services. FIG. 1 shows a service provider 3 operating as an intermediary between a photograph client 1 and a photographer 2. FIG. 2 shows the overall configuration of the system through which the service shown in FIG. 1 is offered. As shown in FIG. 2, the photograph client 1 has a terminal which may comprise, for instance, a personal computer that can be connected to a communication network 4. While the terminal of the photograph client 1 is referred to as a home terminal so as to distinguish it from a terminal of the photographer 2, it may be a mobile terminal similar to that of the photographer 2. The photograph client 1 connects with the communication network 4 by operating the home terminal and accesses the service provider 3 via the communication network 4. The photographer 2 has a terminal which includes an electronic camera 21, a portable telephone 22 and a GPS (global positioning system) device 23. The photographer 2 connects with the communication network 4 via the portable telephone 22 and accesses the service provider 3 via the communication network 4. The service provider 3 has, for instance, a server connected to the communication network 4. The service provider 3 acts as an intermediary to enable an information exchange between the photograph client 1 and the photographer 2.

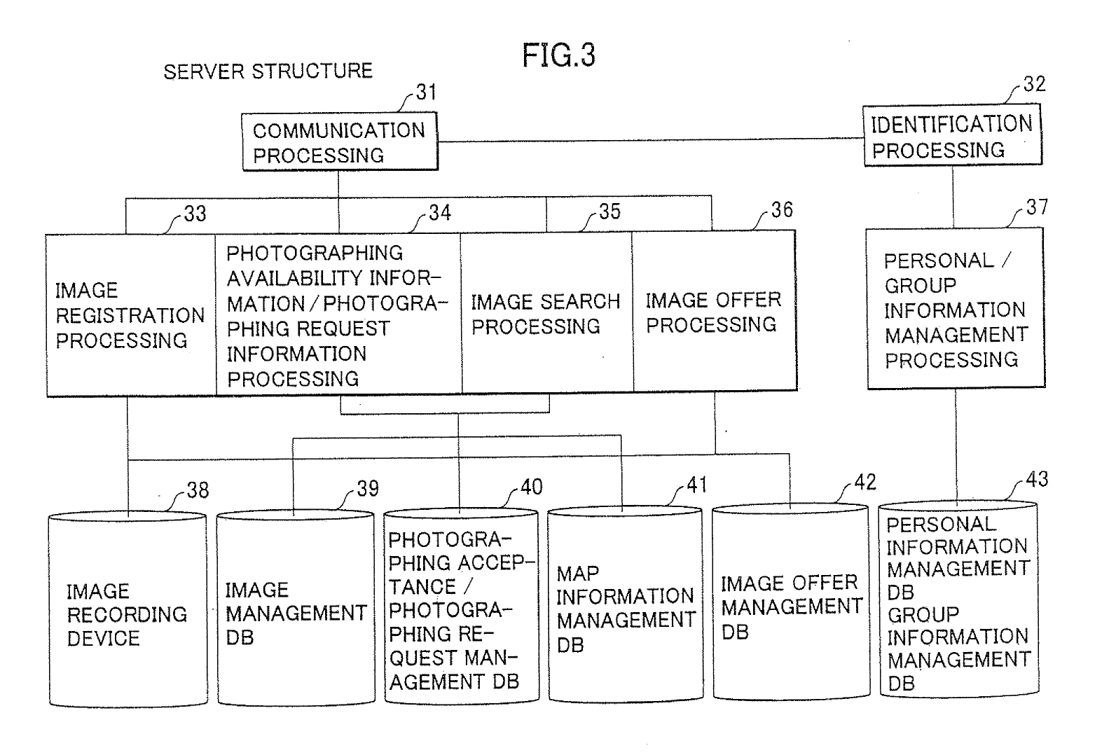

FIG. 3 shows the structure of the server at the service provider. The server in FIG. 3 includes a communication processing unit 31, an identification processing unit 32, an image registration processing unit 33, a photographing availability information/photographing request information processing unit 34, an image search processing unit 35, an image availing processing unit 36, a personal/group information management processing unit 37, an image recording device 38, an image management DB (database) 39, a photographing acceptance/photographing request information management DB 40, a map information management DB 41, an image availing management DB 42 and a personal information management DB/group information management DB 43.

The communication processing unit 31 executes communication processing to enable communication between the server and the communication network 4 (see FIG. 2) in conformance to a predetermined protocol. The identification processing unit 32 makes a decision as to whether or not a service user having accessed the server via the communication network 4 is a pre-registered subscriber. The service user in this situation may be either the photograph client 1 or the photographer 2. The image registration processing unit 33 registers an image photographed by the photographer 2 and transmitted by the photographer 2. The registration of image is a recording of the name of the image data file and information indicating the recording address at which the image data file is recorded into the image management DB 39. The image data registered at the image management DB 39 are recorded into the image recording device 38.

The photographing availability information/photographing request information processing unit 34 records photographing availability information transmitted by the photographer 2 and photographing request information transmitted by the photograph client 1 into the photographing acceptance/photographing request information management DE 40. The photographing availability information having been recorded is posted to the public so that the photograph client 1 can view it. The image search processing unit 35 executes search processing to search for a specific image recorded in the server. The image availing processing unit 36 sets an image recorded in the server in a state in which it can be downloaded by the photograph client 1, i.e., a state in which it is available to be offered to the photograph client 1. Information regarding the image made available to the photograph client is recorded into the image record processing unit 42. The personal/group information management processing unit 37 registers and deletes information with regard to service users. The service user information is recorded into the image management DB processing unit 43. At the communication processing unit 41, map information is recorded.

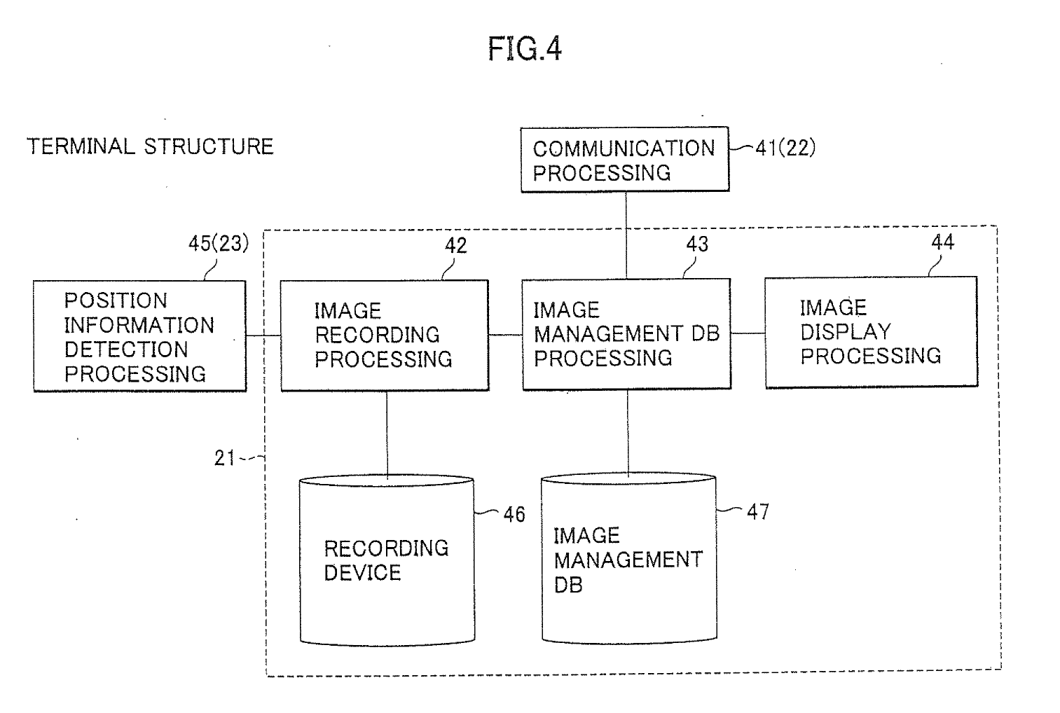

FIG. 4 shows the structure of the photographers terminal. The terminal in FIG. 4 includes a communication processing unit 41, an image record processing unit 42, an image management DB processing unit 43, an image display processing unit 44, a positional information detection processing unit 45, a recording device 46, and an image management DB 47. Of these, the communication processing unit 41 corresponds to the portable telephone 22 in FIG. 2 and the positional information detection processing unit 45 corresponds to the GPS device 23 in FIG. 2. The image record processing unit 42, the image management DB processing unit 43, the image display processing unit 44, the recording device 46 and the image management DB 47 together correspond to the electronic camera 21 shown in FIG. 2.

The communication processing unit 41 executes communication processing to enable communication between the terminal and the communication network 4 (see FIG. 2) in conformance to the predetermined protocol. The image record processing unit 42 records an image photographed by the photographer 2 into the recording device 46. The image management DB processing unit 43 records information indicating the name of the image data file recorded into the recording device 46 and also indicating the recording address at which the image data file is recorded into the image management DB 47. The image display processing unit 44 displays the image at a display (not shown). The positional information detection processing unit 45 generates positional information by detecting the position of the terminal.

The flash report-type image brokering services is provided through the system described above by following the procedural sequence of;

1 public posting of the information indicating the current position of the photographer 2;
2 selection of the photographer 2 by the photograph client 1;
3 agreement reached between the photograph client 1 and the photographer 2;
4 photographing operation performed by the photographer 2; and
5 transfer of the photographed image from the photographer 2 to the photograph client 1.
It is to be noted that prior to subscribing to the service, a service user registers as a user in preparation. The user registers personal identification information and personal information with the server at the service provider as user registration. The personal identification information includes the user name, a password and the name of a group he belongs to. The personal information includes the user name, the e-mail address, the telephone number, the mailing address, the name, the age, the gender, hobbies, preferences and a portrait of the user (an image). Photograph clients and photographers each register as a user with the server from the home terminal or the photographer's terminal. At the server, a given service user is identified by using the personal identification information.

The group name mentioned above is used at the server for group management. A service user can register/delete the name of a group he belongs to by accessing the server from the terminal or the home terminal. In addition, the service user can join/withdraw from a group by accessing the server from the terminal or the home terminal as well. The registered group defines the disclosure range over which the server posts information (photographing availability information/photographing request information) provided by the user, for instance. A service user is allowed to belong to a plurality of groups simultaneously.

Now, in reference to FIG. 1, the specific sequence through which the flash report-type image brokering services is offered is explained. In step S1 in FIG. 1, the photographer 2 registers photographing availability information with the server at the service provider 3. The photographer 2 registers the information by accessing the server from his terminal. The photographing availability information, which is provided by the photographer 2 to the photograph client 1, includes personal information, photographing condition information, disclosure information, remuneration information and photographing history information. The personal information included in the photographing availability information is identical to the personal information registered at the time of the individual user registration described earlier. The photographing condition information includes information indicating the effective limit to the period of time (a specific date/time or a specific length of time) that the photographer will be available to accept a photographing assignment and the photographing position (area within which photographs may be taken). The information indicating the photographing position is constituted of positional information provided by the GPS device 23. The disclosure information and the remuneration information are identical to the disclosure information and the remuneration information included in the image appended information explained earlier. The photographing history information includes information indicating the photographing requests accepted in the past, the evaluations of the photographed images by the clients.

Photographing availability information registered at the server is posted to the public by the server in conformance with the corresponding disclosure information. The range of users to whom the information is disclosed is restricted in conformance to the disclosure range indicated in the disclosure information. Once the effective time limit for accepting a photographing assignment indicated in the photographing condition information expires, the posted photographing availability information is deleted or closed to the public by the server. The photographer 2 can modify the details of the registered photographing availability information by accessing the server from the terminal. In addition, the GPS device 23 at the terminal continuously generates positional information at all times at least while the photographing availability information is posted. Thus, as the photographer 2 moves, the current positional information is transmitted from the terminal to the server. As a result, the information indicating the photographing position which is included in the photographing condition information contained in the photographing availability information managed by the server is updated with predetermined update timing.

In step S2 in FIG. 1, the photograph client 1 accesses the server at the service provider 3 and registers photographing request information. In step S3, the photograph client 1 accesses the server at the service provider 3 to conduct a photographer search. At the server, photographing availability information that satisfies the conditions indicated in the photographing request information is searched from the registered photographing availability information and a list of eligible photographers is transmitted to the home terminal. The photograph client 1 searches for a desirable photographer by using the photographer list transmitted to his home terminal.

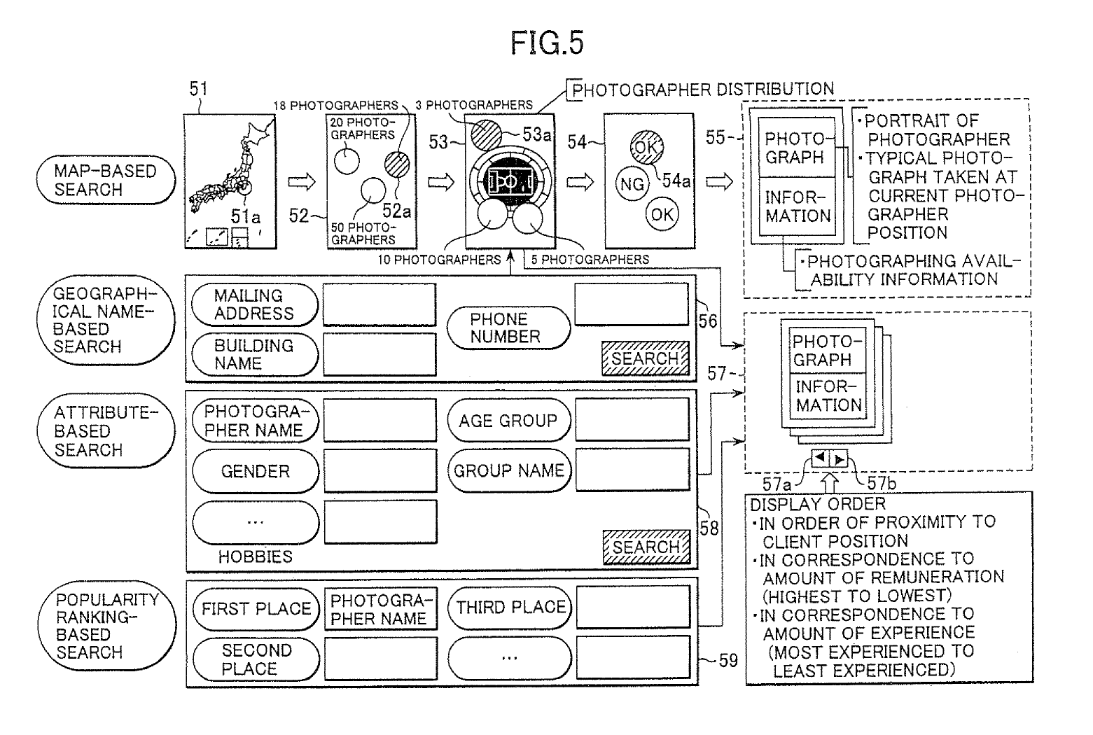

FIG. 5 presents examples of search screens that may be brought up on display at the home terminal when the photograph client 1 searches for the most desirable photographer 2. The search may be conducted by using a map, by using a geographical name as an index, through an attribute-based search or based upon the photographer popularity ranking.

—Map-Based Search—

If a map-based search is selected, a wide area map screen 51 is brought up on display. As the photograph client 1 specifies a desired photographing position 51a on the screen 51 with a pointing device (not shown), an enlarged map screen 52 is brought up on display. On this screen, an area over which photographers 2 registered with the server are present and the distribution of the photographers within this area are indicated. The specific positions at which the photographers 2 are present are indicated based upon the positional information provided by the GPS devices 23, which is included in the photographing availability information explained above.

As the photograph client 1 specifies a desired photographing area 52a on the screen 52 with the pointing device, a screen 53 of the area in a further enlargement is brought up on display. As in the case of the screen 52, an area over which photographers 2 registered with the server are present and the number of photographers present within the area are indicated on the screen 53. In this example, the screen 53 indicates specific areas of the spectator stands in a stadium and the exact number of photographers 2 present within each area. As the photograph client 1 specifies a desired photographing position 53a on the screen 53 with the pointing device, a screen 54 indicating the specific positions of the individual photographers 2 is brought up on display. On the screen 54, the position of each photographer 2 is indicated together with information indicating whether the photographer 2 can accept (OK) the photographing assignment or he cannot accept (NG) the photographing assignment since he is already working on another photographing assignment, for instance. As the photograph client 1 selects an icon 54a indicating the desired photographer 2 with a pointing device, a screen 55 that provides a profile of the photographer 2 is brought up on display. On the screen 55, a photograph is displayed together with the photographing availability information provided by the photographer 2. The photograph on display may be a portrait of the photographer 2 or a typical photograph taken in the vicinity of the position at which the photographer 2 is currently present, and the photographic image display can be switched through a key operation at the home terminal or the like. Thus, the photograph client 1 is allowed to select the most desirable photographer to be assigned with the photographing task by conducting a search.

—Geographical Name-Based Search—

If the photograph client 1 chooses to search for the photographer by using a geographical name as an index, an input screen 56 is brought up on display. The photograph client 1 enters information related to the geographical name of the desired photographing location on the screen 56 by using a keyboard (not shown). The information entered by the photograph client 1 includes the mailing address (postal code), the name of the bui lding (name of the facility) and the telephone number. While this information may be entered in full, the photograph client 1 is also allowed to enter only part of the information available to him. As he clicks a search button on the screen 56 after entering the geographical name information, a screen of an area searched by using the geographical name as the index, e.g., the screen 53 of the stadium described earlier, is brought up on display. As explained above, among photographers 2 registered with the server, the photographers 2 currently present within the area are searched and the distribution of the photographers 2 within the area is indicated.

As the photograph client 1 specifies the desired photographing position 53a on the screen 53 with the pointing device, a screen 57 is brought up on display. The screen 57 presents all the photographers 2 that are currently available to accept the photographing assignment (OK) and are present within an area corresponding to the position 53a. On the screen 57, a photograph is displayed together with the photographing availability information provided by each of the photographers 2. The photograph on display is a portrait of the photographer 2 or a typical photograph taken in the vicinity of the position at which the photographer 2 is currently present and the photographic image display can be switched through a key operation or the like performed at the home terminal. At the bottom of the screen 57, arrow buttons 57a and 57b are displayed. As the photograph client 1 clicks either the arrow button 57a or the arrow button 57b, another photographer 2 present within the specified area is introduced. If the photograph client 1 clicks the arrow button 57b, the photographer 2 following the current photographer in the lineup is introduced, whereas if the photograph client 1 clicks the arrow button 57a, the display returns to the photographer 2 preceding the current photographer in the lineup. It is to be noted that a plurality of the lineups in which the individual photographers 2 are introduced are provided and one of the specific lineups can be selected by the photograph client 1 through a key operation at the home terminal. The services may provide a positional lineup in which the photographer present at a position closest to the photograph client 1 is placed first in the lineup order, a remuneration lineup in which the photographer available at the lowest rate is placed first in the lineup order, and an experience lineup in which the photographer with the most photographing experience is placed first in the lineup order or the like.

—Attribute-Based Search—

If the photograph client 1 chooses to conduct an attribute-based search, an input screen 58 is brought up on display. The photograph client 1 enters information related to the photographer whom the photograph client 1 wishes to assign by using a keyboard (not shown) on the screen 58. The information entered by the photograph client 1 includes the name of the photographer, the age group to which the photographer belongs, the gender, the name of a group to which he belongs and his hobbies. At this time, only the information indicating the name of the photographer, for instance, may be entered so as to specify the exact photographer 2 or only information indicating a specific age group or a specific agenda may be entered so as to select a specific type of photographer 2. As a search button on the screen 58 is clicked after entering the information related to the desired photographer 2, photographers 2 who satisfy the conditions that have been entered are searched. After the search, all the photographers 2 that are available to accept the photographing assignment (OK) and are present within the area corresponding to the position 53a are introduced on a screen 57. It is to be noted that the photographers 2 introduced on the screen 57 are present in the vicinity of the desired photographing position specified by the photograph client 1.

—Photographer Popularity Ranking-Based Search—

If the client 1 chooses to search for a photographer based upon the photographer popularity ranking, a screen 59 is brought up on display. On the screen 59, the names of the photographers having received the greatest numbers of photographing requests in the past are presented in the order of popularity. It goes without saying these photographers 2 are present in the vicinity of the desired photographing position specified by the photograph client 1. As the photograph client 1 changes the screen with the pointing device (not shown), a screen 57 on which the photographers 2 placed in the popularity ranking are introduced is brought up on display. Their ranks of the individual photographers in popularity are determined by the server based upon the photographing history information included in the photographing availability information which is registered at the server.

The photographer 2 may be selected through a manual selection in which the photograph client 1 selects the desired photographer 2 by operating the home terminal, or through an automatic selection in which a photographer 2 satisfying the condition is automatically selected by the server. The specific type of selection processing to be executed can be determined on the home terminal side. In the case of manual selection, the photograph client 1 searches for eligible photographers 2 through any one of the search methods described earlier and selects the photographer to be assigned. In the case of the automatic selection, a screen 55 with the profile of the selected photographer 2 is brought up on display at the home terminal. As explained earlier, a photograph is displayed together with the photographing availability information provided by the photographer 2 on the screen 55. It is to be noted that a plurality of photographers 2 may be selected.

An automatic selection may be executed by, for instance, searching for an eligible photographer 2 who is currently present at the photographing location entered by the image data creation client 1 as the request information. If there are a plurality of photographers currently present in the same area, the client 1 can make a selection on a screen which is to be detailed later.

The selected photographer 2 is notified through any of the following methods. The specific method of notification should be indicated by the photographer 2 in the photographing availability information registered at the service provider 3, for instance.

(1) The service provider 3 sends a notification (via e-mail, pager or the like) to the photographer 2.
(2) The service provider 3 connects the photograph client 1 and the photographer 2 via telephone.
(3) The service provider 3 notifies the photographer 2 on a chat line (through real-time text dialogue).

Upon receiving the notification from the service provider 3, the photographer 2 responds in any of the following methods.

(1) The photographer 2 sends a reply (via e-mail, pager or the like) to the service provider 3.
(2) The photographer 2 responds on a telephone line connected to the photograph client 1 by the service provider 3.
(3) The photographer 2 responds to the service provider 3 on a chat line.
As the photographer 2 responds to the notification sent to the photographer 2 from the service provider 3, a contract is established between the photograph client 1 and the photographer 2. It is to be noted that the contracting process executed as described in (1) through (3) above may be omitted.

The photographing request information registered by the photograph client 1 at the server of the service provider 3, is information that is provided by the photograph client 1 to photographers 2, which includes personal information, photographing condition information, disclosure information, remuneration information and photographing preference information. The personal information is identical to the personal information registered at the time of the individual user registration explained earlier. The photographing condition information includes information indicating the effective time limit (a specific date, a specific time period) on the time during which a photographing request is valid and a specific photographing position (a requested photographing area). The disclosure information and the remuneration information are identical to the information included in the image appended information mentioned earlier. The photographing preference information includes information indicating a photographic subject, a specific photographing angle (the photographing direction), a composition, a photographing volume (the number of photographs to be taken, the length of photographing time period, etc.) and whether or not photographs should be taken through continuous shooting. The photographing preference information may also include information indicating a photographing azimuth.

The photographing request information registered at the server is posted by the server as indicated in the disclosure information. The range of users to whom the information is disclosed is restricted in conformance to the disclosure range indicated in the disclosure information. Once the effective time limit for the photograph request indicated in the photographing condition information passes, the disclosed photographing request information is deleted or closed to the public by the server. The photograph client 1 can modify the details of the registered photographing request information.

In step S4 in FIG. 1, the photographer 2 having been selected through the process described above performs a photographing operation as requested in the photographing request information. The photographer 2 checks the photographing request information provided by the photograph client 1 by accessing the server at the service provider 3 from his terminal. The photograph client 1 may ask the photographer 2 to perform a test photographing operation (the photograph client 1 may ask for an image for preview). The photographer 2 in turn may send a test image (a preview image) to the photograph client 1. The photographing preferences may be communicated through the photographing request information and also, they may be verbally communicated during a telephone conversation between the photographer 2 and the photograph client 1. By communicating the photographing preferences after checking the preview image, the photograph client 1 is able to provide the photographer with more specific photographing instructions, e.g., “further to the right”. It is to be noted that the preview image may be a real time image (a dynamic image).

The shutter timing with which an image is photographed on the electronic camera 21 may be determined by the photographer 2 performing the shutter release operation, or the timing may be determined by the photograph client 1 by transmitting a shutter control signal from the home terminal to the electronic camera 21 via the communication network 4.

In step S5 in FIG. 1, the photographer 2 registers the photographed image by accessing the server at the service provider 3 from his terminal. The image data are recorded at the server at this time. The service provider 3 sends a notification of an URL (uniform resource locator) at which the image data are stored together with a notification of the registration of an image satisfying the conditions indicated in the photographing request information to the photograph client 1. The notifications may be sent via e-mail, a pager, a chat line or a voice dialogue. The specific method through which the notifications are to be provided should be indicated by, for instance, the photograph client 1 in the photographing request information registered at the service provider 3. In step S6, the photograph client 1 downloads the image satisfying the conditions indicated in the photographing request information from the storage location (at the service provider 3) indicated by the notified URL. Thus, the photograph client 1 receives the requested image.

When the photographer 2 registers the photographed image by accessing the server at the service provider 3 from the terminal, the image data themselves do not need to be recorded at the server. In such a case, the image data are recorded at the terminal of the photographer 2. The service provider 3 notifies the photograph client 1 of the URL at the photographer's terminal, at which the image data are stored, when it notifies the photograph client 1 that an image satisfying the conditions indicated in the photographing request information has been registered. In step S6a, the photograph client 1 downloads the image satisfying the conditions indicated in the photographing request information from the storage location (at the terminal of the photographer 2) indicated by the notified URL. Through this process, the photograph client 1 receives the requested images.

Alternatively, the photographer 2 may directly transmit an image satisfying the conditions indicated in the photographing request information to the photograph client 1. In such a case, the photographer 2 directly transmits the image to the home terminal of the photograph client 1 from his terminal in step S6b. Through this process, too, the requested image is delivered to the photograph client 1. It is to be noted that an image may be directly transmitted from the terminal of the photographer 2 to the home terminal of the photograph client 1 in an attached file in an e-mail in conformance to the FTP (file transfer protocol) or the like.

Now, the enumeration information posted by the server is explained. The photograph client 1 and the photographer 2 both pay a facility user fee when a photograph is to be taken at a fee-charging facility. The server posts to the photographer 2 the amount of money calculated by adding the facility user fee onto the amount indicated in the remuneration information registered by the photograph client 1. The server also posts to the photograph client 1 the amount of money calculated by adding the facility user fee onto the amount indicated in the remuneration information registered by the photographer 2. As a result, when photographs are taken at fee charging facilities, the facility user fees are incurred by the service users.

The following advantages are achieved in the first embodiment explained above.

(1) The photographer 2 posts photographing availability information by accessing the server at the service provider 3 from his terminal, whereas the photograph client 1 posts photographing request information by accessing the server at the service provider 3 from the home terminal. Thus, the photographer 2 is able to solicit a photographing assignment from a wide range of photograph clients 1 who are complete strangers, when he is available to accept a photographing assignment at the current location. At the same time, the photograph client 1 is able to place a photographing request whenever he needs an image and is also able to obtain a current image of a desired photographing location even when the photographing location is far away from the location of the photograph client 1.
(2) The photograph client 1 can select a desirable photographer 2 assigned to photograph an image desired by the client based upon the posted photographing availability information provided by the photographers 2 by operating his home terminal. When selecting the desirable photographer 2, the photograph client 1 conducts a search of the photographers 2 from the home terminal. Namely, by conducting a map-based search, a geographical name-based search, an attribute-based search, a popularity ranking-based search or the like, the best photographer 2 to photograph images desired by the photograph client 1 can be selected.
(3) Since the distribution of individual photographers 2 is mapped on the map displayed in the search screen at the home terminal of the photograph client 1 during the map-based search or the geographical name-based search mentioned above in (2), the positions of the photographers 2 can be ascertained with ease. Since the position of each photographer 2 is indicated based upon the positional information provided by the GPS device 23 at the terminal of the photographer 2, the display position is updated whenever the photographer moves. As a result, the search of the most desirable photographer 2 can be conducted by using the most recent positional information at all times.

The photographer 2 may accept photographing requests placed by a plurality of photograph clients 1. In such a case, the photographer 2 should indicate that he is capable of accepting another photographing assignment (OK) even while he is engaged in a photographing operation when he registers the photographing availability information. Consequently, he is allowed to accept photographing assignments from a plurality of photograph clients 1 at the same time.

The photograph client 1 in the first embodiment may be a nominal photograph client. Namely, an image photographed by the photographer 2 may be delivered to a third party other than the photograph client 1. In this case, as the photograph client 1 receives the notification of the registration of an image satisfying the conditions indicated in the photographing request information and the notification of the URL at which the image data are stored from the service provider 3, the photograph client 1 informs the third party, i.e., the true client, of the details of the notifications. As a result, the true client is able to receive the image from the URL. Through the system, photographs can be ordered by the nominal client experienced in placing photographing assignments on behalf of customers who may be unfamiliar with the procedure. In addition, such a system can be used to advantage when a person wishes to send images as a gift to a third party.

In the explanation given above, all the contents of the items included in the photographing availability information and the photographing request information are disclosed to parties that fall within the range of disclosure indicated in the disclosure information. Instead, according to the wishes of each photographer 2 or photograph client 1, specific restrictions may be imposed with regard to the disclosure of the individual items, e.g., the disclosure of the personal information may be disallowed.

The flash report-type image brokering services explained above can be used when a client wishes to obtain scoop images provided by a freelance photographer or an amateur photographer, when a client wishes to obtain current images of a location he visited in the past, when a client wishes to obtain current images of a location he is going to visit in the future, when a client wishes to obtain current images of a location he cannot travel to himself and the like.

While an explanation has been given on an example in which the terminal carried by the photographer 2 is constituted of three devices, i.e., the portable telephone 22, the electronic camera 21 and the GPS device 23, the functions of the individual devices may be integrated. For instance, the photographer 2 may carry a terminal constituted only of an electronic camera 23 having the communication function achieved by the portable telephone 22 in the explanation and the positional information detection function achieved by the GPS device 23 in the explanation.

The search screen explained in reference to FIG. 5 above may instead be switched in the following manner.

—Map-Based Search—

While an explanation has been given above on an example in which after the screen 51 is displayed, the screen 55 is brought up on display via the screen 53, the screen 57 may be brought up on display instead of the screen 55. In addition, directly after the screen 51 is displayed, the screen 55 may be brought up on display without displaying the screen 53, or after the screen 51 is displayed, the screen 57 may be directly brought up on display without displaying the screen 53.

—Geographical Name-Based Search—

While an explanation has been given above on an example in which after the screen 56 is displayed, the screen 57 is brought up on display via the screen 53, the screen 55 may be brought up on display instead of the screen 57. In addition, directly after the screen 56 is displayed, the screen 55 may be brought up on display without displaying the screen 53, or after the screen 56 is displayed, the screen 57 may be directly brought up on display without displaying the screen 53.

—Attribute-Based Search—

While an explanation has been given above on an example in which after the screen 58 is displayed, the screen 57 is next brought up on display, the screen 55 may be brought up on display instead of the screen 57. In addition, after the screen 58 is displayed, the screen 55 may be brought up on display following the display of the screen 53, or after the screen 58 is displayed, the screen 57 may be brought up on display via the screen 53.

—Photographer Popularity Ranking-Based Search—

while an explanation has been given above on an example in which after the screen 59 is displayed, the screen 57 is next brought up on display, the screen 55 may be brought up on display instead of the screen 57. In addition, after the screen 59 is displayed, the screen 55 may be brought up on display following the display of the screen 53, or after the screen 59 is displayed, the screen 57 may be brought up on display via the screen 53.

In the image brokering services achieved in the first embodiment, an advertisement may be attached to an image provided to the photograph client 1. In such a case, part of the image brokering services user fee can be incurred by the sponsor. An advertisement should be attached to the image with the following timing. When the photograph client 1 receives the image in step S6 as described above, the service provider 3 attaches the advertisement to the image. If, on the other hand, the photograph client 1 receives the image in step S6a or step S6b, the photographer 2 attaches the advertisement to the image. The advertisement that is attached to the image at this time may be an advertisement provided by the service provider 3 in advance or an advertisement for the photographer 2 himself. When the service provider 3 adds an advertisement to the image data, the advertisement is appended by the server. When the photographer 2 adds an advertisement to the image data, the advertisement is added by the electronic camera 21 at the terminal.

When there are a plurality of advertisers, the service provider 3 selects an advertisement to be attached to the image based upon the personal information registered by the photograph client 1. For instance, if the photograph client 1 is interested in a car, an advertisement for an auto manufacturer is attached to the images provided to this particular photograph client 1. In addition, the advertisement may be attached each time the photograph client 1 uses the image brokering services, and the size and the content of the attached advertisement may be altered depending upon the number of times the particular client has used the service.

The advertisement attached to the image may be superimposed on the image itself, or the image and the advertisement may be provided as separate data. The specific mode in which the advertisement is to be attached can be specified by the photograph client 1 in the photographing request information he registers. In addition, the photograph client 1 can specifically indicate that he does not wish to have any advertisement attached in the photographing request information he registers. If the photograph client 1 does not wish to receive any advertisement, the photograph client 1 incurs the full image brokering services user fee.

### Second Embodiment

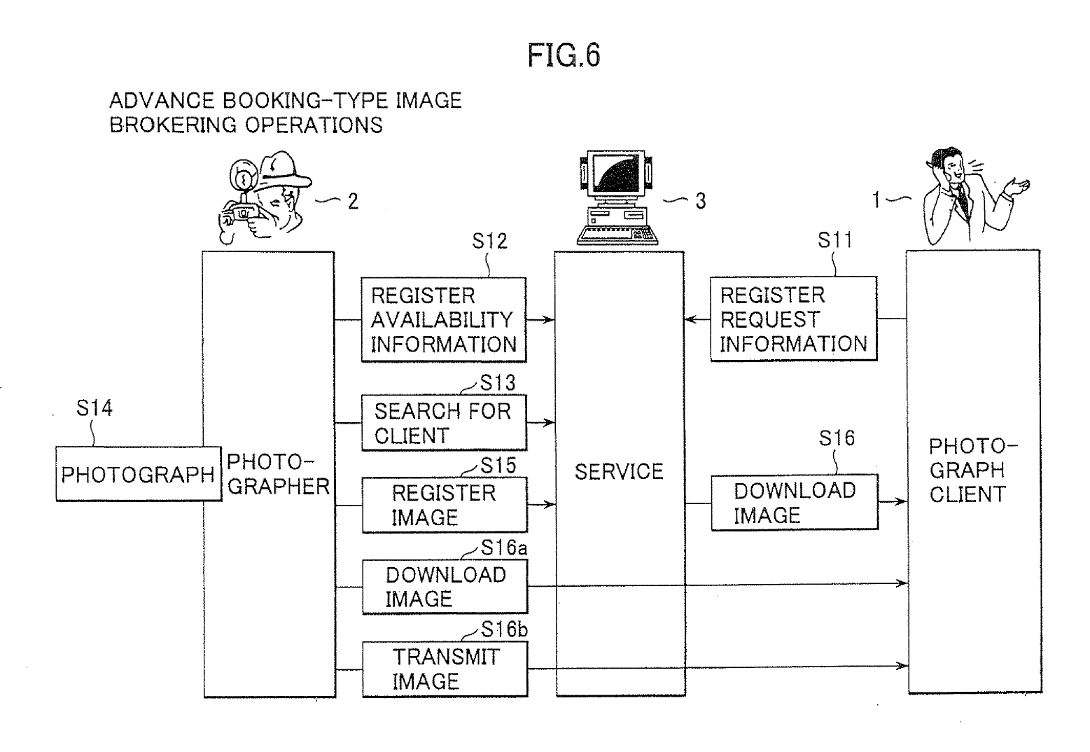

The image brokering services achieved in the second embodiment is an advance booking-type image brokering services in which a photograph client places a photographing request in advance, a photographer performs a photographing operation in response to the photographing request and the photographed image is provided to the client. FIG. 6 presents an overview of the advance booking-type image brokering services. As shown in FIG. 6, a service provider 3 acts as an intermediary between a photograph client 1 and a photographer 2. The overall structure of the system through which the service shown in FIG. 6 is offered is identical to that shown in FIG. 2 explained earlier. The service provider 3 enables an information exchange between the photograph client 1 and the photographer 2.

The sequence through which the advance booking-type image brokering services is offered is as follows:

1 photograph clients 1 post information on requested photographing points;
2 the photographer 2 selects a desirable photograph client 1;
3 a contract is reached between the photographer 2 and the photograph client 1;
4 the photographer 2 performs a photographing operation; and
5 the photographed image is transferred from the photographer 2 to the photograph client 1. It is to be noted that as in the first embodiment, each service user registers himself as a user in preparation for subscribing to the service.

The specific procedural steps taken to provide the advance booking-type image brokering services are now explained in reference to FIG. 6. In step S11 in FIG. 6, the photograph client 1 registers photographing request information at the server of the service provider 3. The registration is performed by the photograph client 1 by accessing the server from the home terminal.

The photographing request information, which is disclosed by the photograph client 1 to photographers 2, includes personal information, photographing condition information, disclosure information, remuneration information and photographing preference information. The personal information is identical to the personal information registered at the time of the individual user registration explained earlier. The photographing condition information includes information indicating the effective time limit (a specific date, a specific time period) on the time during which a photographing request is valid and a specific photographing position (a requested photographing area). The disclosure information and the remuneration information are identical to the information included in the image appended information mentioned earlier. The photographing preference information includes information indicating a photographic subject, a photographing angle, a composition, a photographing volume (the number of photographs to be taken, the length of photographing time period, etc.) and whether or not photographs should be taken through continuous shooting.

The photographing request information registered at the server is posted by the server as indicated in the disclosure information. The range of users to whom the information is disclosed is restricted in conformance to the disclosure range identified in the disclosure information. Once the effective time limit for the photographing request indicated in the photographing condition information expires, the disclosed photographing request information is deleted or closed to the public by the server. The photograph client 1 can modify the details of the registered photographing request information by accessing the server from the home terminal.

In step S12 in FIG. 6, the photographer 2 accesses the server and registers photographing availability information. The photographing availability information, which is disclosed by the photographer 2 to the photograph client 1, includes personal information, photographing condition information, disclosure information, remuneration information and photographing history information. The personal information is identical to the personal information registered at the time of the individual user registration described earlier. The photographing condition information includes information indicating the effective time limit (a specific date, a specific time period) on the time during which a photographing request is valid and a specific photographing position (a requested photographing area). The disclosure information and the remuneration information are identical to information included in the image appended information explained earlier. The photographing history information includes information indicating the photographing assignments accepted in the past, the evaluations of the photographed images by the clients.

Photographing availability information registered at the server is posted to the public by the server in conformance with the corresponding disclosure information. The range of users to whom the information is disclosed is restricted in conformance to the disclosure range included in the disclosure information. Once the effective time limit for accepting a photographing assignment included in the photographing condition information expires, the posted photographing availability information is deleted or closed to the public by the server. The photographer 2 can modify the details of the registered photographing availability information.

In step S13, the photographer 2 accesses the server at the service provider 3 to conduct a photograph client search. At the server, photographing request information that satisfies the conditions indicated in the photographing availability information is searched from the registered photographing request information and a list of eligible photograph clients is transmitted to the terminal. The photographer 2 searches for a desirable photograph client by using the photograph client list transmitted to the terminal. Since the search screens brought up on display in this situation are similar to those shown in FIG. 5, their explanation is omitted.

The photograph client 1 may be selected through a manual selection in which the photographer 2 selects the desired photograph client 1 by operating the terminal or through an automatic selection in which a photograph client 1 satisfying the conditions is automatically selected by the server. The specific type of selection processing to be executed can be determined on the terminal side. In the case of manual selection, the photographer 2 selects a photograph client 1 from the photograph client list sent to his terminal. In the case of the automatic selection, a screen (not shown) with the profile of the selected photograph client 1 is brought up on display at the terminal. It is to be noted that a plurality of photograph clients 1 may be selected.

The automatic selection may be executed by, for instance, comparing desired photographing locations indicated in the request information originating from photograph clients 1 and the possible photographing location indicated in the availability information originating from the photographer 2. Namely, a search may be conducted for a desired photographing location matching the possible photographing location information resulting from the search may be transmitted to the corresponding photograph client 1 and a request instruction originating from the client 1 may be transferred to the photographer 2.

The selected photograph client 1 is notified through any of the following methods. The specific method of notification should be indicated by the photograph client 1 in the photographing request information registered at the service provider 3, for instance.

(1) The service provider 3 sends a notification (via e-mail, pager or the like) to the photograph client 1.
(2) The service provider 3 connects the photographer 2 and the photograph client 1 via telephone.
(3) The service provider 3 notifies the photograph client 1 on a chat line (through a real-time text dialogue).
Upon receiving the notification from the service provider 3, the photographer 2 responds in any of the following methods.
(1) The photograph client 1 sends a reply (via e-mail, pager or the like) to the service provider 3.
(2) The photograph client 1 responds on a telephone line connected to the photographer 2 by the service provider 3.
(3) The photograph client 1 responds to the service provider 3 on a chat line.
As the photograph client 1 responds to the notification sent to the photograph client 1 from the service provider 3, a contract is established between the photographer 2 and the photograph client 1. It is to be noted that the contracting process executed as described in (1) through (3) above may be omitted.

In step S14 in FIG. 6, the photographer 2 performs a photographing operation as requested in the photographing request information. The photographer 2 checks the photographing request information provided by the photograph client 1 by accessing the server at the service provider 3 from his terminal. The photograph client 1 may ask the photographer 2 to perform a test photographing operation (the photograph client 1 may ask for an image for preview). The photographer 2 in turn may send a test image (a preview image) to the photograph client 1. The photographing preferences may be communicated through the photographing request information and also, they may be verbally communicated during a telephone conversation between the photographer 2 and the photograph client 1. By communicating the photographing preferences after checking the preview image, the photograph client 1 is able to provide the photographer with more specific photographing instructions, e.g., “further to the right”.

The shutter release timing with which the photographer 2 photographs an image with the electric camera 21 constituting the terminal may be determined by the photographer 2 performing the shutter release operation or by the photograph client 1 by transmitting a shutter control signal from the home terminal to the electronic camera 21 via the communication network 4.

In step S15 in FIG. 6, the photographer 2 registers the photographed image by accessing the server at the service provider 3 from his terminal. The image data, too, are recorded at the server at this time. The service provider 3 sends a notification of an URL (Uniform Resource Locator) at which the image data are stored together with a notification of the registration of an image satisfying the conditions indicated in the photographing request information to the photograph client 1. The notification may be sent via e-mail, pager, chat line or voice dialogue. The specific method through which the notifications are to be provided should be indicated by, for instance, the photograph client 1 in the photographing request information registered at the service provider 3. In step S16, the photograph client 1 downloads the images satisfying the conditions indicated in the photographing request information from the storage location (at the service provider 3) indicated by the notified URL. Thus, the photograph client 1 receives the requested image.

The image may be transferred as in step S16a, in which the photograph client 1 downloads the image data from the terminal of the photographer 2, or as in step S16b, in which the photographer 2 directly transmits the image data to the photograph client 1, instead. Since these transfer operations are respectively identical to the image transfer operations executed in step S6a and step S6b in the first embodiment, their explanation is omitted.

In the second embodiment described above, photograph clients 1 disclose photographing request information by accessing the server at the service provider 3 from their home terminals and photographers 2 post photographing availability information by accessing the server at the service provider 3 from their terminals. Thus, the photograph clients 1 may invite a complete stranger who is not a friend or acquaintance to provide a desired image. At the same time, the photographers 2 are each allowed to select a desirable photograph client 1 through a search of the posted photographing request information, and thus, the photographers 2 can choose photographing assignments they accept.

Since fixed cameras are not used in the advance booking-type image brokering services explained above, no restrictions are enforced with regard to the photographing angle. Thus, the advance booking-type image brokering services can be used effectively when images photographed at a predetermined time point are needed to ascertain the traffic flow, when images photographed at a predetermined time point are needed to ascertain how crowded a tourist spot (facility) is, when images photographed at a predetermined time point are needed to ascertain the state of snow accumulation, when images photographed at a predetermined time point are needed to ascertain the wave conditions, when images photographed at a predetermined time point are needed to ascertain the weather, when images are needed to conduct an ecological survey of wildlife and the like. In addition, since an image photographed by the photographer 2 located at the position desired by the photograph client 1 is provided to the photograph client 1, the images can be utilized to verify that a specific checkpoint in a rally, an orienteering event or the like has been reached. In such a case, a participant in the race acts as the photographer and the organizer of the event is the photograph client.

In the image brokering service achieved in the second embodiment, too, an advertisement may be attached to an image provided to the photograph client 1. An advertisement should be attached to the image with the following timing. When the photograph client 1 receives the image in step S16 described above, the service provider 3 attaches an advertisement to the image. If, on the other hand, the photograph client 1 receives the image in step S16a or step S16b, the photographer 2 attaches an advertisement to the image. The advertisement that is attached to the image at this time may be an advertisement provided by the service provider 3 in advance or an advertisement for the photographer 2 himself. When the service provider 3 adds an advertisement to the image data, the advertisement is appended by the server. When the photographer 2 adds an advertisement to the image data, the advertisement is appended by the electronic camera 21 at the terminal.

### Third Embodiment

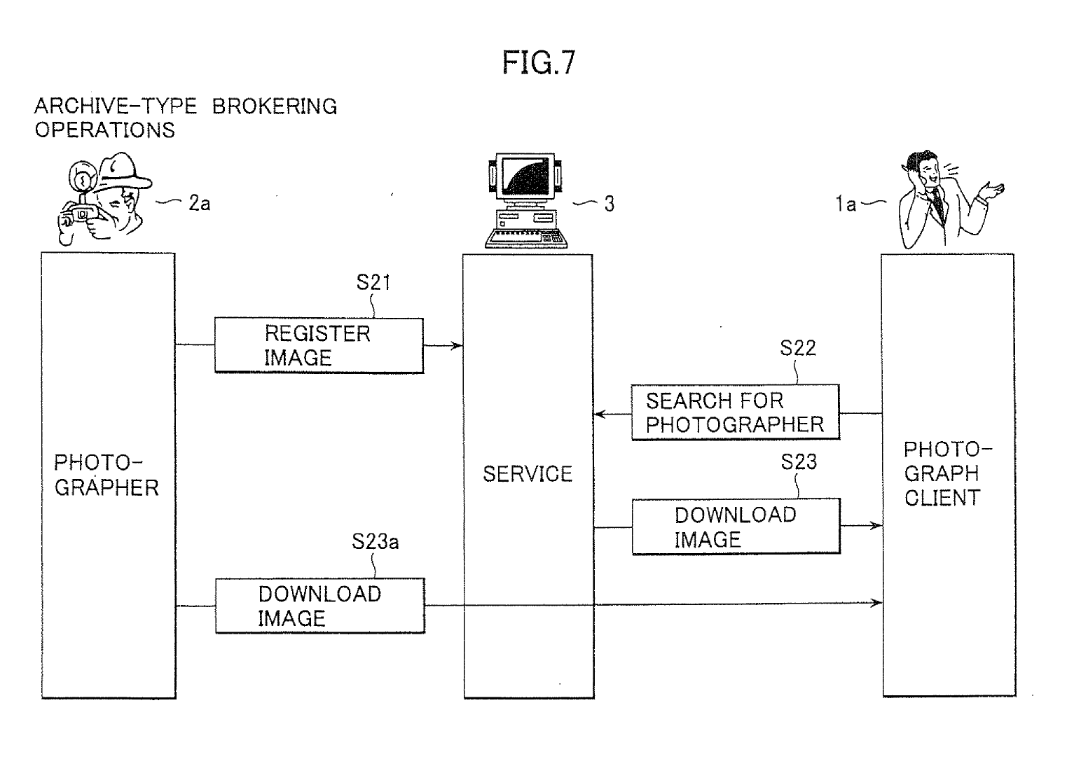

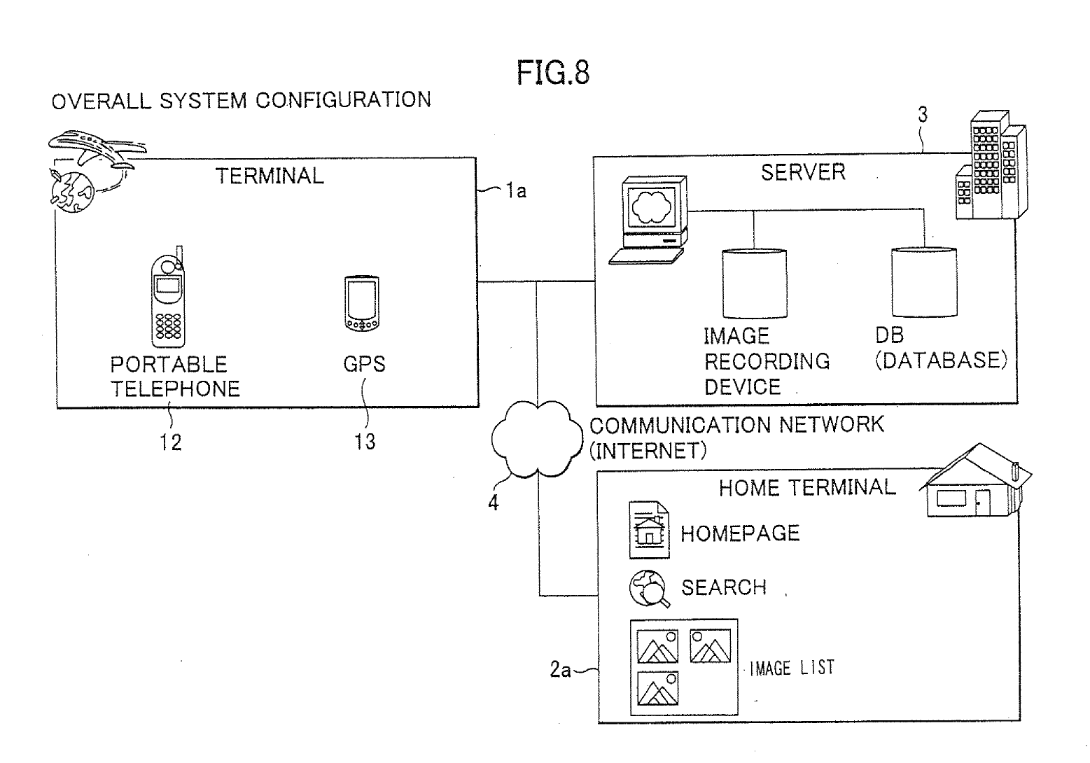

The image brokering services achieved in the third embodiment is an archive-type image brokering services that allows a photographer having photographed an image in the past at a location where a photograph client is currently visiting to provide the images to the photograph client. FIG. 7 presents an overview of the archive-type image brokering services. FIG. 7 shows a service provider 3 operating as an intermediary between a photograph client 1a and a photographer 2a. FIG. 8 shows the overall configuration of the system through which the service shown in FIG. 7 is offered. As shown in FIG. 8, the photograph client 1a has a terminal which includes at least a portable telephone 12 and GPS device 13. The terminal of the photograph client 1a may include a function as an electronic camera as well. The photograph client 1a connects with the communication network 4 through the portable telephone 12 and accesses the service provider 3 via the communication network 4. The photographer 2a has a terminal comprising, for instance, a personal computer that can be connected with the communication network 4. In this explanation, the terminal of the photographer 2a is referred to as a home terminal in order to distinguish it from the terminal of the photograph client 1a. The photographer 2a connects with the communication network 4 by operating the home terminal and accesses the service provider 3 via the communication network 4. The service provider 3 has, for instance, a server connected to the communication network 4. The service provider 3 acts as an intermediary to enable an information exchange between the photograph client 1a and the photographer 2a.

The sequence through which the archive-type image brokering services is offered is as follows:

1 each photographer 2a performs a photographing operation at a given photographing position;
2 the image photographed by the photographer 2a is registered together with photographing positional information;
3 the photograph client 1a selects an image matching positional information indicating his own position;
4 contract is established between the photograph client 1a and the photographer 2a; and
5 the images are transferred from the photographer 2a to the photograph client 1a.
It is to be noted that each service user registers himself as a user prior to subscribing to the service, as in the first embodiment.

Now, in reference to FIG. 7, the specific procedural sequence through which the archive-type image brokering services is offered is explained. In step S21 in FIG. 7, the photographer 2a registers an image by the accessing the server of the service provider 3. The registration is executed by the photographer 2a by accessing the server from his home terminal. At this time, he also registers photographing availability information that includes positional information indicating the position at which the image was photographed. The photographing availability information, which is disclosed by the photographer 2a to the photograph client 1a, includes personal information, photographing condition information, disclosure information, remuneration information and photographing history information. The contents of the individual types of information are identical to those in the first embodiment explained earlier. Photographing availability information registered at the server is posted to the public by the server in conformance with the corresponding disclosure information. The range of users to whom the information is disclosed is restricted in conformance to the disclosure range included in the disclosure information. Once the effective time limit for accepting a photographing assignment included in the photographing condition information expires, the posted photographing availability information is deleted or closed to the public by the server.

In step S22 in FIG. 7, the photograph client 1a accesses the server at the service provider 3 and conducts an image search. The search is conducted by the photograph client 1a by accessing the server from his terminal. The photograph client 1a transmits photographing request information to be detailed later from the terminal to the server. At the server, photographing availability information satisfying the conditions indicated in the photographing request information is searched from the registered photographing availability information and a list of eligible photographers is transmitted to the terminal.

The photographing request information, which is disclosed by the photograph client 1a to the service provider 3, includes personal information, photographing condition information, disclosure information, remuneration information and photographing preference information. The personal information is identical to the personal information registered at the time of the individual user registration explained earlier. The photographing condition information includes information indicating the effective time limit (a specific date, a specific time period) during which a photographing request is valid and a specific photographing position. The photographing position is indicated based upon the positional information provided by the GPS device 13 at the terminal of the photograph client 1a. The GPS device 13 continuously generates positional information at least while the photographing request information is posted. Thus, as the photograph client 1a moves around, the updated positional information is transmitted from the terminal to the server and the information indicating the photographing position is updated with predetermined update timing. The disclosure information and the remuneration information are identical to the information included in the image appended information mentioned earlier. The photographing preference information includes information indicating a photographic subject, a specific photographing angle, a composition, a photographing volume (the number of photographs to be taken, the length of photographing time period, etc.) and whether or not photographs should be taken through continuous shooting.

The desired photographer 2a and image are selected either through a manual selection in which the photograph client 1a selects a desired photographer 2a and a desired image by operating the terminal or through an automatic selection in which a photographer 2a and an image provided by the photographer 2a that satisfy the conditions are automatically selected at the server. Either type of selection processing can be selected on the terminal side. In the case of manual selection, the photograph client 1a selects the most desirable photographer 2a and image by checking the photographer list transmitted to the terminal. In the case of automatic selection, a screen (not shown) introducing the selected photographer 2a and the selected images photographed by the photographer 2a are brought up on display at the display at the terminal.

The automatic selection can be executed by, for instance, comparing the desired photographing location indicated in the request information originating from the photograph client 1 and image data photographing positions registered in advance by photographers 2a. Namely, image data that include photographing position data matching the desired photographing location are searched, information resulting from the search is transmitted to the client 1a and then the image data are delivered to the photograph client 1a in response to a purchase instruction originating from the client 1a.

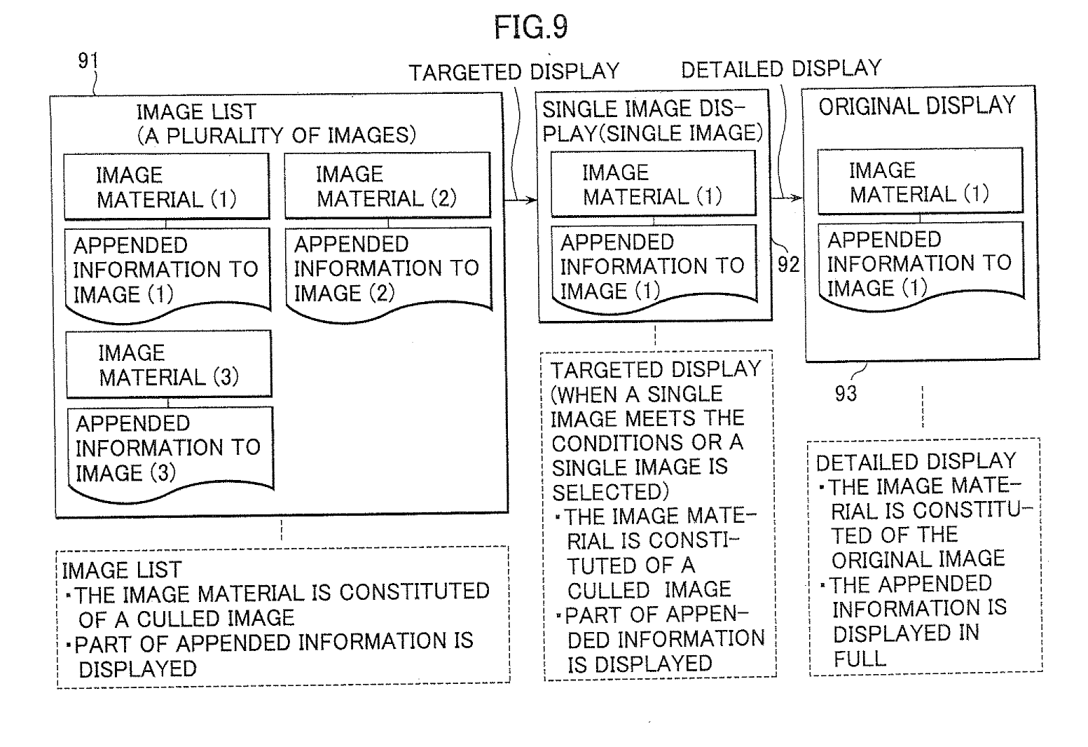

FIG. 9 presents an example of the image list brought up at the screen of the terminal. The display mode can be switched between the image list (a plurality of images) brought up on a screen 91 and the single image display (single image) brought up on a screen 92. Either of the display modes can be selected by the photograph client 1a through a key operation performed at the terminal. As the photograph client 1a specifies a desired image (1) in the image list the screen 91 with a pointing device (not shown), the display mode is switched to the single image display on the screen 92. Each image displayed on the screen 91 or the screen 92 is constituted of an image material and image appended information with regard to the image. The image material is a culled image having undergone culling processing so as to display only part of the actual image (the original material). In addition, the image appended information is partially displayed.

As the photograph client 1a responds to the server by indicating a specific image material he desires, a contract is established between the photographer 2a and the photograph client 1a. The server at the service provider 3 then notifies the photograph client 1a of the URL at which the image data are stored. The notification may be sent via e-mail, pager, chat line or voice dialogue. The specific method through which the notification is to be provided should be indicated by, for instance, the photograph client 1a in the photographing request information registered at the service provider 3. It is to be noted that a plurality of image materials, i.e., a plurality of photographers 2a, may be selected.

In step S23 in FIG. 7, the photograph client 1a downloads an image satisfying the conditions indicated in the photographing request information from the storage location (at the service provider 3) indicated by the notified URL. Thus, the photograph client 1a receives the requested image. In FIG. 9, the original image received by the client 1a is displayed on a screen 93. The image material (1) displayed on the screen 93 is the original image that did not undergo the culling processing. In addition, the image appended information is the full information.

It is to be noted that the image may be transferred as in step S23a, in which the photograph client 1a downloads the image data from the home terminal of the photographer 2a. In this case, the photographer 2a registers only the photographing availability information including information of the image photographing position without register of the actual image and the image data are stored at the home terminal of the photographer 2a.

In the third embodiment explained above, photographers 2a each register an image photographed at a given photographing position at the server of the service provider 3 together with the photographing availability information including information of the image photographing position. Photograph clients 1a each access the server of the service provider 3 from the terminal to disclose photographing request information that includes positional information indicating his current position. The service provider 3 executes a search to determine whether or not there is any registered image satisfying the conditions indicated in the photographing request information and notifies the photograph client 1a of the URL of the image data satisfying the conditions after the search. Thus, the photograph client 1a can obtain an image having been photographed in the past at the location he is currently visiting.

The archive-type image brokering services explained above can be used by a photograph client visiting a given location to obtain an image having been photographed in the past at the same location, e.g., an image having been photographed at a different time of the day, during a different season or before the surrounding landscape changed, to obtain an image having been photographed on another camera or the like. In addition, through this service, the positional information provided by the GPS device 13 can be used to prove that the photograph client 1a is actually present at the location when the photograph client 1a posts the photographing request information. There is an added advantage in that the service promotes a friendly communication among service users since the photographer 2a and the photograph client 1a having visited the same location share a common topic of interest.

In the image brokering services achieved in the third embodiment, too, an advertisement may be attached to an image provided to the photograph client 1a. An advertisement should be attached to the image with the following timing. When the photograph client 1a receives the image in step S23 as described above, the service provider 3 attaches an advertisement to the image. If, on the other hand, the photograph client 1a receives the image in step S23a, the photographer 2a attaches an advertisement to the image. The advertisement that is attached to the image at this time may be an advertisement provided by the service provider 3 in advance or an advertisement for the photographer 2a himself. When the service provider 3 adds an advertisement to the image data, the advertisement is appended by the server. When the photographer 2a adds an advertisement to the image data, the advertisement is added at the home terminal.

In the first through third embodiments individually explained above, the photographer and the photograph client are often total strangers. In this situation, the mediation provided by the service provider allows them to remain anonymous to each other.

Instead of the GPS device used to generate the photographer positional information or the photograph client positional information, an IMT-2000 (International Mobile Telecommunication 2000) compliant mobile telephone or a PHS terminal capable of obtaining positional information may be used.

In addition, the positional information explained above includes information indicating the azimuth and information indicating the angle of elevation. Thus, the azimuth on which the camera is held and the photographing angle can be ascertained from the positional information. The azimuth information may be obtained from, for instance, an azimuth sensor provided at the terminal, and the elevation angle information may be obtained from, for instance, an attitude sensor provided at the terminal.

The terminal described above may be an electronic camera, a portable telephone, a portable information terminal (PDA), a game station, a game terminal or the like. Namely, the terminal simply needs to have, at least, an image photographing function, a communication function and a positional information generating function.

The home terminal described above may be any of the devices that can be used to constitute the terminal described above, a personal computer, an L-mode-compliant telephone, a set-top box (STB) or the like.

In addition, instead of setting up the server, the terminal and the home terminal as three separate entities, as described above, the server and the terminal or the server and the home terminal may be integrated.

While the services are provided in the systems that include a terminal, a server and a home terminal in the explanation given above, a program for providing an image brokering services offered through the use of the individual devices in the explanation given above may be provided so that an electronic camera, a personal computer or the like having the program installed therein may be used as an image brokering services device. In such a case, an electronic camera, a server and a personal computer in which the program loaded is executed, can be used as the terminal, the server and the home terminal respectively.

A digital data brokering services program through which the digital data brokering services in the first embodiment (the flash report-type service) is offered should be stored at the server of the service provider 3 and be programmed so as to enable execution of at least the following processing. Namely, it should enable execution of:
first receiving/transmitting processing through which availability information that includes digital data creator positional information and originates from a creator is received/transmitted;
second receiving/transmitting processing through which request information that includes a digital data creation condition desired by a client and originates from the client is received/transmitted;
comparison processing through which the availability information and the request information are compared;
third receiving/transmitting processing through which a digital data creation instruction is transmitted to/received by the creator if at least the positional information is judged to satisfy the creation condition as a result of the comparison processing; and
fourth receiving/transmitting processing through which information required to deliver digital data created by the creator after receiving the creation instruction to the client is received/transmitted.

A digital data brokering services program through which the digital data brokering services in the second embodiment (the advance booking-type service) is offered should be stored at the server of the service provider 3 and be programmed so as to enable execution of at least the following processing. Namely, it should enable execution of:
first receiving/transmitting processing through which request information that includes a desired digital data creation condition and originates from a client is received/transmitted;
second receiving/transmitting processing through which availability information originating from a creator is received/transmitted;
comparison processing through which the request information and the availability information are compared;
third receiving/transmitting processing through which a digital data creation instruction is transmitted to/received by the creator if the creation condition is judged to match the availability information as a result of the comparison processing; and
fourth receiving/transmitting processing through which information required to deliver digital data created by the creator after receiving the creation instruction to the client is received/transmitted.

A digital data brokering services program through which the digital data brokering services in the third embodiment (the archive-type service) is offered should be stored at the server of the service provider 3 and be programmed so as to enable execution of at least the following processing. Namely, it should enable execution of:
first receiving/transmitting processing through which digital data creation location information originating from digital data creators is received/transmitted;
second receiving/transmitting processing through which request information that includes current location information indicating the current location of a client and originates from the client is received/transmitted;
comparison processing through which the creation location information and the current location information are compared; and
third receiving/transmitting processing through which information required to deliver digital data with at least the creation location information thereof judged to match the current location information based upon results of the comparison processing to the client is received/transmitted. In the first receiving/transmitting processing, the digital data themselves are received/transmitted together with the digital data creation location information.

According to the present invention, which provides mediation between photographers and clients so as to enable an exchange of digital data (such as image data) currently available or digital data to be created in the future, availability information originating from digital data creators (such as photographers) is obtained, request information originating from a digital data client is obtained, a digital data creation instruction is transmitted to a creator selected based upon the availability information and the request information, and digital data created by the creator having received the creation instruction are delivered to the client. Accordingly, no restrictions whatsoever are imposed by the embodiment explained earlier on the scope of the present invention as long as data are exchanged through such mediation.

According to the present invention, the current positions of digital data creators are ascertained, the position requested by a digital, data creation client is ascertained, the current positions and the requested position thus ascertained are compared, and an instruction is issued to a digital data creator currently located at a position matching the requested position to allow the creator to create digital data. Accordingly, no restrictions whatsoever are imposed by the embodiment explained earlier on the scope of the present invention as long as data are exchanged through such mediation.

According to the present invention, which provides mediation between creators and clients to enable an exchange of digital data having been created in the past, creation location information indicating digital data creation locations originating from digital data creators is obtained, digital data creation request information that includes current positional information indicating the current position of a client originating from the client is obtained, the creation location information and the current positional information are compared, and digital data corresponding to creation location information matching the current positional information are delivered to the client. Accordingly, no restrictions whatsoever are imposed by the embodiment explained earlier on the scope of the present invention as long as data are exchanged through such mediation.

### INDUSTRIAL APPLICABILITY

While an explanation is given above on examples in which image handling services are offered, the present invention may be adopted in conjunction with audio data obtained on a video camera or a recording device or text data created on a text creating device such as a word processor instead of image data. Namely, the present invention may be adopted to offer a service in which another type of digital data such as audio data or text data instead of image data is handled. The audio data exchanged through the service should be data that can be obtained only at a specific location such as the sound of a waterfall. The text data handled in the service may be printed matter such as a flier distributed at a given location or a novel set at a specific location.

1. A digital data brokering method comprising:
obtaining positional information indicating current positions sent by digital data creators;
posting the current positions to the public;
obtaining a creation request sent by a digital data creation client based upon the posted current positions;
transmitting a creation instruction to a digital data creator corresponding to the creation request thus obtained; and
delivering digital data created by the creator having received the creation instruction to the client.
